(19) United States
(12) Patent Application Publication
(10) Pub. No.: US 2006/0124321 A1
(43) Pub. Date: Jun. 15, 2006

(54) Fire retardant distribution system for wildfire protection

(75) Inventors: James A. Aamodt, Sisters, OR (US); Stanley Brock, West Point, NY (US)

Correspondence Address: IPSOLON LLP, 111 SW COLUMBIA, SUITE 710, PORTLAND, OR, 97201, US

(73) Assignee: Firebreak Spray Systems, LLC

(21) Appl. No.: 11/349,584

(22) Filed: Feb. 8, 2006

Related U.S. Application Data
(62) Division of application No. 11/001,527, filed on Dec. 1, 2004.

(51) Int. Cl. A62C 2/00; A62C 13/62; B05B 7/04; A62C 3/00

(52) U.S. Cl. 169/44; 239/398; 239/303

(57) ABSTRACT

A fire retardant distribution system is designed for use with any type of structure such as residences, out buildings, barns, commercial buildings, and others. The system is designed to prevent structures from catching fire when a wildfire approaches, and relies upon a spray system that when activated coats the exterior of the structures, decks and surrounding landscape very rapidly with a liquid, decolorized fire retardant that remains on the surface until washed off. The system is self-contained and relies upon tanks pressurized with inert gas to deliver the fire retardant to spray valves positioned on and around the structures and surrounding areas. In an alternate embodiment, compressed gas-powered pumps deliver fire retardant to desired areas to flank a wildfire and control its direction and behavior.

### RELATED APPLICATION INFORMATION

This application is a division of U.S. patent application Ser. No. 11/001,527, filed Dec. 1, 2004.

### FIELD OF THE INVENTION

This invention relates to apparatus and methods designed to protect structures from wildfire and/or to control wildfire behavior and direction, and more specifically, to a fire retardant system for distributing fire retardant in desired areas around and on the exterior surfaces of structures when needed, or in specific areas to impede wildfire progress.

### BACKGROUND

In recent years numerous wildfires, particularly in the Western regions of the United States, have destroyed thousands of homes and other structures. While these fires have been concentrated primarily in the Western states, the risk from wildfire to residences exists throughout the U.S. and in other parts of the world.

Over the past several decades there has been an increasing migration of population from cities and towns toward rural areas, and there has been a dramatic increase in the number of homes and communities being built at the interfaces between urban and forest lands-the so-called “urban-wildland” interface. As more homes and communities are built along the boundaries between urban and forested areas, and particularly in areas that are historically burned by wildfires, more and more of these structures are directly exposed to the risks of destruction by wildfires. This population and construction trend, coupled with historical timber management practices that have led to increased forest fuel loading in recent years, and drought conditions existing across the Western U.S. have led to an unprecedented number of structures being in danger of exposure to wildfires.

Conventional methods of fighting wildfires often have little impact when the fires enter the urban-wildland interface where residential subdivisions have been built, and wildfire fighters often can only stand back and watch as homes in the path of a wildfire are destroyed. The inability to prevent wildfire from destroying communities has been seen dramatically in the past several years, during which several highly publicized wild fires destroy thousands of homes in throughout the West, including Southern California, Nevada, Utah and other states.

The costs of fighting wildfires can be enormous. During the wildfire season of 2003, the costs of fighting wildfires in the Western portion of the U.S. have been estimated to be in the hundreds of millions of dollars.

But the costs associated with fighting wildfires pale in comparison to the costs of lost homes and other structures destroyed by wildfires. For example, according to the Insurance Services Office, Inc. (www.iso.com), the estimated insured losses arising out of the wildfires in San Diego and San Bernardino counties in Southern California in 2003 alone exceed over $2 billion. Of this, over $1 billion in payments arise out of a single wildfire—the Cedar Fire—which destroyed over 2,200 residential and commercial buildings. On a nationwide basis, the annual insured losses attributable to wildfires are undoubtedly much higher.

Given the staggering amounts of economic and environmental damage caused by wildfires, there is increasing interest in mitigation techniques that reduce the risks to both communities and forest lands. With respect to homes and communities, there are numerous wildfire mitigation strategies that can be taken to alleviate the risk of wildfires destroying residences. These include relatively simple measures such as establishing an effective “defensible space” around homes located in at-risk areas. Another simple approach that many communities have adopted on a community-wide basis is decreasing the fuel loads around urban-wildland interfaces. Good community planning before residential areas are built is also important, since it may be unwise to locate residential developments in areas that are highly prone to wildfires.

Nonetheless, homes, commercial structures and other buildings continue to be built at the edges of the urban areas where the risk of wildfire is the greatest, and even deep in forested areas. Accordingly, there is an immediate need for systems for reducing the risk that wildfires will destroy structures such as homes and the like, wherever they are built.

### BRIEF DESCRIPTION OF THE DRAWINGS

The invention will be better understood and its numerous objects and advantages will be apparent by reference to the following detailed description of the invention when taken in conjunction with the following drawings.

FIG. 1 is a schematic top plan view of a residential structure and the area surrounding the structure, illustrating one preferred embodiment of the fire retardant distribution system according to the present invention.

FIG. 2 is a schematic layout view of the fire retardant distribution system shown in FIG. 1 with the structure removed to illustrate the system.

FIG. 3 is a schematic view of the primary systems according to the present invention, including the distribution system, the storage system and the control system.

FIG. 4 is a schematic view of the control system according to the present invention.

FIG. 5 is a schematic top plan view of a perimeter fire retardant distribution system according to a second illustrated embodiment of the present invention.

### DETAILED DESCRIPTION OF THE PREFERRED EMBODIMENTS

A first preferred and illustrated embodiment of the present invention is a fire retardant distribution system for use with any type of structures including residences, out buildings, barns, commercial buildings, and others. The system is designed to prevent structures from catching fire when a wildfire approaches, and relies upon a spray system that when activated quenches and coats the exterior of the structures, decks and surrounding landscape very rapidly with a liquid fire retardant that remains on the surface until washed off. The system is self-contained and relies upon tanks pressurized with inert gas to deliver the fire retardant to spray valves positioned on and around the structures. There is no need for electrical power, although electrical power may be supplied by the utility with battery backup if an electrically operated control system is used. The system may be activated manually, or may optionally include a control module that allows the system to be activated in any number of ways, including manually and remotely by telephone.

A second preferred and illustrated embodiment of the present invention comprises a pump powered by compressed gas that is connected to a reservoir of non-pressurized retardant and a series of distribution guns connected to the outflow of the pump. The distribution guns are positioned to spray retardant in a line that either blocks progress of a wildfire, or channels the direction of the fire in a desired manner. Several subsystems, each comprising a pump and the associated distribution guns may be laid out in series so that a fire retardant protection line several miles long may be quickly laid down on vegetation. This “flanking” technique allows fire fighters to control fire direction and behavior at critical points, typically near communities.

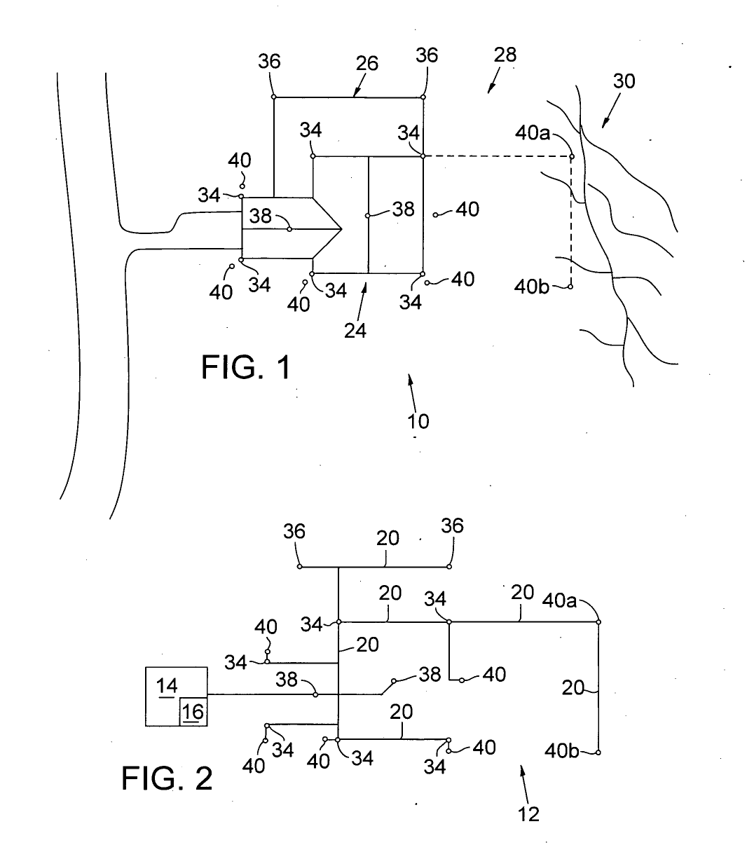

With reference now to FIGS. 1 and 2, a fire retardant distribution system 10 is illustrated schematically in a typical installment in a residential setting that includes a building 24 such as a typical home located near an urban-wildfire interface area. The system 10 includes several different components or subsystems, including a distribution system shown generally at 12 and comprising the pipes and nozzle systems through which liquid fire retardant is delivered to and applied on surfaces, a fire retardant storage system shown generally at 14 and comprising the storage tanks for storing liquid fire retardant when the system is not in use, and pressurization tanks for pressurizing the system and associated hardware, and a control system shown generally at 16 and comprising generally the devices necessary for activating the distribution system 10. Each of these components is described in detail below.

The system 10 shown in the figures illustrates a typical residential installation in which the system is configured to deliver fire retardant to exterior surfaces of the building 24, a deck 26 attached to the building, and surrounding areas such as landscaping 28. In FIG. 1, the building is shown located adjacent to a canyon area 30.

The distribution system 12 is shown in isolation in FIG. 2 and comprises a system-of pipes 20 and spray nozzles connected to the pipes at desired positions. The distribution system 12 illustrated herein also includes pipes 20 extending to the edge of the canyon area 30. The type and size of piping 20 used in a distribution system 12 depends on factors such as the size of the system and the amount of liquid retardant that will be delivered through it. Generally, most any type of tubing will work well for the pipes 20 used in system 12, including for example PVC, poly or copper tubing. If the latter or any metallic pipe is used, care must be taken to avoid corrosion from the particular retardant that is used. The diameter of the pipe 20 also depends on the volume of retardant delivered through the system, the operating pressures, etc.

The pipes 20 and associated spray nozzles define a distribution system 12 for the liquid fire retardant contained in the storage system 14. The piping is connected to the various source tanks for the fire retardant as described below and is plumbed through the walls of the structure or is buried underground in the case of landscape nozzles. Preferably, the piping 20 is installed during initial construction of the building 24 so that it may be installed in an “in-wall” manner, under sheet rock and the like. However, the system 10 may be retrofitted into existing buildings, in which cases the piping 20 is run under eves and the like in a manner designed to be as inconspicuous as possible.

The distribution system 12 includes several different types of nozzles, each having a specific purpose. For example, exterior wall nozzles 34 are located at strategic positions along the perimeter of the building 24 so that the exterior surfaces of the building 24 are coated with fire retardant when the system is activated. Thus, wall nozzles 34 are mounted under the eves or overhangs of building 24 and are configured to direct a sprayed stream of liquid fire retardant onto the exterior walls of the building. There are six wall nozzles 34 shown in FIGS. 1 and 2, but as many wall nozzles are plumbed into the system as are necessary to coat the entire exterior wall surface area. Typically, wall nozzles 34 are mounted about every 30 lineal feet along the length of the wall.

Likewise, the system 10 shown in FIGS. 1 and 2 includes two deck nozzles 36 located around deck 26. These deck nozzles direct a spray onto the horizontal surface of the deck and if desired, may be the type of nozzles that rotate through a complete circle so that they also deliver fire retardant to adjacent landscape areas.

In FIGS. 1 and 2 there are two roof nozzles 38 situated so that they spray the entire roof surface. And the system 10 shown in FIGS. 1 and 2 includes seven separate landscape nozzles 40 positioned around the landscaping 28, two of which are positioned adjacent the canyon area 30 (labeled 40a, 40b). It will be appreciated that the pipe 20 is preferably buried underground in the landscaped areas.

Each of the nozzles used with system 10 is of a type appropriate for the specific location. Wall nozzles 34 typically are misting nozzles having about ½ inch diameter. These nozzles are mounted under the eves of the building such that the nozzles protrudes about 1 and ½ inches from the eve on which they are mounted. These nozzles may be plastic or stainless steel. Typically, these nozzles do not rotate but instead direct a spray stream directly onto the vertical walls of the building. Nonetheless, these nozzles may be configured to rotate when they are pressurized to thereby spray fire retardant onto the adjacent vertical wall surfaces and onto adjacent surfaces such as soffetts, decks and the surrounding exterior ground.

The deck nozzles 36 may be of the type typically seen in in-ground irrigation systems, such as pressure pop-up rotating spray nozzles. These nozzles may be set to rotate through a complete 360° angle, or only part of a circle. Impact nozzles may also be used for the deck nozzles.

Roof nozzles 38 may be of the pop-up type, or impact type. Preferably, all nozzles in system 10 are mounted so that they are either concealed or minimally visible when not in use to not detract from the appearance of building 24. Thus, pop-up type nozzles may be mounted in the ground or in special boxes mounted on the deck. Similarly, the roof nozzles 38 may be mounted in architectural features on the peak of the roof such as cupolas or dormers. The cupola may be built to include blowout louvers and similar fittings that are instantly blown out when fire retardant begins spraying out of a nozzle. A cupola also may be built to accommodate a pop-up sprinkler head for use in the roof nozzle 38. Regardless of the type of nozzle used, there are sufficient roof nozzles 38 located along the peaks and ridges of the building's roof so that the entire roof is coated with fire retardant.

Similarly, the landscape nozzles 40 are selected to be of a type that is appropriate to the particular location. Pressure pop-up type nozzles are preferred, but impact heads also work well. With respect to the two landscape nozzles 40a and 40b located adjacent the edge of canyon area 30, these typically would be impact heads, or “gun”-types of agricultural heads.

The distribution system 12 is not charged with fire retardant when the system is not in use. In other words, the pipe 20 is empty when the system is not in use. This eliminates any problems with freezing or corrosion from fire retardant resident in the pipes in the case where copper pipes are being used.

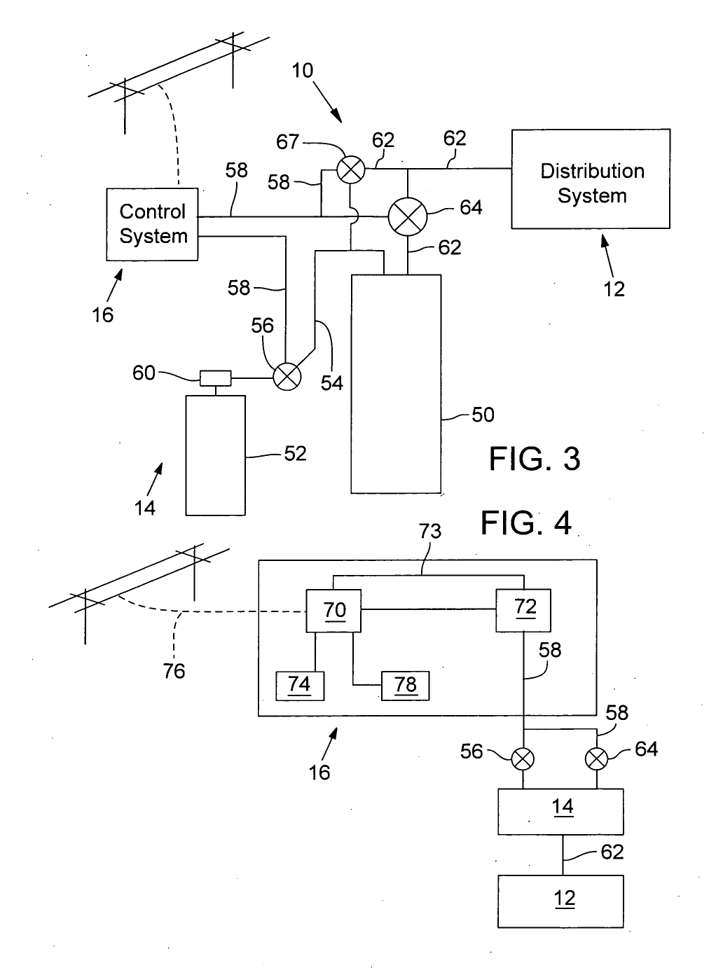

The storage system 14 will now be described in detail with particular reference to FIG. 3. In FIG. 3 the distribution system 12, storage system 14 and control system 16 are shown schematically. Storage system 14 comprises one or more fire retardant tanks, pressurization systems, and control valves for operating the system. Specifically, the storage system 14 illustrated in FIG. 3 utilizes a single fire retardant tank 50 and a single pressurization tank 52. Fire retardant tank 50 contains the liquid fire retardant and stores the retardant when the system 10 is not in use. The size and volume of fire retardant tank 50 varies according to the size of system 10. The tank 50 is sized so that the tank has adequate volume to spray the desired volume of liquid fire retardant over the entire area intended to by covered by the system 10. A variety of tank types may be used for tank 50. Preferably, tank 50 is a steel tank lined with a liner material such as epoxy coatings that are impervious to the liquid fire retardant to thereby prevent corrosion in the tank. In a typical residential installation, tank 50 is sized to a capacity between about 100 to about 350 gallons. Larger tanks of up to 10,000 gallons or more may be used with large structures or where retardant is to be sprayed over a large area or in community-based systems.

Some kinds of fire retardants that may be used in system 10 tend to stratify over time. Depending upon the type of fire retardant used, tank 50 may be fitted with agitators such as bubblers or paddle-type mixers to keep the fire retardant homogenous over time. A secondary bubbling line (not shown) may be run from the pressure tank 52 into the fire retardant tank 50 to cause either continuous or intermittent bubbling of nitrogen gas through the fire retardant to mix the fire retardant and thus prevent stratification. The control system 16 may be configured to provide bubbling into the fire retardant tank when the system 10 is activated in order to mix the fire retardant.

Fire retardant tank 50 is plumbed to pressure tank 52 through a pressure line 54. A valve 56 is in pressure line 54 and is, as detailed below, connected to and operable under the control of control system 16 through control line 58. A system flush pipe 65 branches from pressure line 54 and connects to outlet pipe 62 downstream of valve 64. A valve 67 is plumbed into flush pipe 65. The function of system flush pipe 65 is explained below.

Pressure tank 52 is a cylinder charged with an inert pressurized gas such as nitrogen that serves as the force for pressurizing the system 10 to deliver fire retardant through pipes 20 to the various nozzles. Pressure tank 52 is of a sufficient volume and is charged to an appropriate pressure such that when the system 10 is activated, all of the fire retardant contained in fire retardant tank 50 is delivered through the nozzles at an operating pressure appropriate to the system—typically about 60 psi. A pressure regulator 60 is typically used to regulate operating pressure of gas delivered from pressure tank 52 to fire retardant tank 50 and the nozzles downstream of the tank 50. The fire retardant tank 50 is capable of being pressurized up to about 80 psi and above.

Fire retardant contained in tank 50 is delivered to the piping 20 of distribution system 12 through an outlet pipe 62. As noted, a valve 64, which is under the control of control system 16 through control line 58 is plumbed into outlet pipe 62 near tank 50.

In most installations of system 10, the storage system 14 may be located in any appropriate setting such as in a garage, HVAC area, or out building.

It will be appreciated that storage system 14 may utilize multiple fire retardant tanks 50 and multiple pressure tanks 52 if the size of the system 10 is sufficient to warrant the capacity added by multiple tanks.

Control system 16 is shown schematically in detail in FIG. 4 and includes an activation switch 70, which is typically an electronic switch, and an auxiliary power supply 72 such as a battery and/or uninterrupted power supply module. Activation switch 70 is the main on/off switch for activating system 10 and is normally powered by the power supply to the building. However, in wildfire situations electric power from public utilities and the like may be cut off. Auxiliary power supply 72 provides electric power to activation switch 70 through wiring 74 to ensure that activation switch 70 is powered under all circumstances, even where external electrical power supply has been interrupted. As indicated earlier, control lines 58 interconnect control system 16 to valves 58 and 64, which preferably are electrically operated solenoid valves. Alternately, all of the valves described herein may be operated pneumatically, or manually, depending upon the type of system that is being used.

Activation switch 70 is operable under a variety of input systems that are capable of activating system 10. For example, switch 70 may be activated with a manual switch 74 that is preferably located in the building 24. If a wildfire is approaching the building, the manual switch 74 is activated to begin activation of the system 10. Activation switch 70 is further operable via telephonic activation 76. Thus, control system 16 may include telephony systems wired to the phone lines or cellular or satellite phone systems so that switch 70 may be remotely operated by calling a specific telephone number and entering the appropriate codes. The building owner, the local fire departments, etc. may access the telephonic activation 76 by dialing the number. Switch 70 may also be operated by on-site detectors 78 such as infrared detectors located around the building, or by RF controlled devices. For example, an infrared detector may be located near the edge of canyon area 30. If a wildfire is detected, the detector is capable of activating switch 70. Similarly, heat sensors and other types of similar sensor may be located around or near a building, or near the edge of canyon area 30 and configured for activating system 10.

The fire retardant used in system 10 is preferably a liquid that flows readily through the plumbing systems and through the nozzles. Because the retardant may not be used for several years after tank 50 is filled, the retardant is preferably not prone to degradation in effectiveness over time. And because the fire retardant is sprayed over buildings, the retardant preferably does not discolor building surfaces, does not harm vegetation, and causes no environmental damage. A variety of fire retardants suitable for use in system 10 are commercially available. Liquid fire retardant compositions available from Astaris (www.astaris.com) and sold under the brand name PHOS CHEK™ are one example of suitable fire retardants. Another suitable retardant is available under the brand name FIRE-TROL™ from various sources including www.firetrolcanada.com. Preferably the fire retardant that is used in system contains no colorants and/or is decolorized.

Operation of system 10 will now be detailed. When system 10 is not in use, or “idle”, the fire retardant tank 50 is filled with liquid fire retardant but is not pressurized. Valves 56, 64 and 67 are closed. System 10 is activated in any number of the ways detailed above. For purposes of illustration, in this case it is assumed that the system 10 is installed in a residential structure as illustrated and that the owner of the structure has been evacuated by authorities in view of the threat posed by an approaching wildfire. In other words, the system 10 was not activated prior to the building being evacuated. When the owner deems that the structure is imminently threatened by wildfire, the owner calls the number for the telephonic activation 76 of control system 16 on either a landline or cellular phone. The telephonic activation 76 is configured to answer the phone call and prompt the caller to enter specific codes in order to activate activation switch 70—that is, to turn switch 70 from the “off” to the “on” position. For example, the telephonic activation 76 may prompt the caller to enter an authorization code to first insure that the caller is authorized to give the system further instructions. If the correct authorization code is entered, the telephonic activation 76 will next prompt the caller to enter a specific activation code in order to activate activation switch 70.

When the caller enters the activation code control system 16 sends appropriate signals to valves 56 and 64, which as noted are electrically operated valves such as solenoid valves, causing the valves to open. As valve 56 opens gas from pressure tank 52 flows into and pressurizes fire retardant tank 50. With valve 64 open, fire retardant contained in tank 50 begins flowing into outlet pipe 62 under the pressurizing force applied by gas from pressure tank 52, and thus into the entire distribution system 12. The liquid fire retardant flows quickly into pipes 20 and immediately begins to be discharged from each of the nozzles in the system. Although the nozzles in the system are configured to apply the desired amount of liquid fire retardant onto adjacent surfaces, a typical application rate is about 2 gallons per 100 square feet of surface. This application rate may vary with the type of fire retardant used.

The fire retardant is sprayed out of the nozzles onto the intended surfaces until either the entire content of fire retardant contained in tank 50 is sprayed through the nozzles, or the system is deactivated by deactivating switch 70—that is, the switch 70 is moved from the “on” to the “off” position. In this regard, pressure tank 52 contains enough pressurized gas to discharge the entire contents of fire retardant contained in tank 50 when tank 50 is full, and to clear all fire retardant contained in all plumbing lines in distribution system 12. Thus, if the system 10 remains activated until all fire retardant is discharged through the nozzles, gas from pressure tank 52 will flush all plumbing lines of fire retardant.

Similarly, the activation switch 70 may be turned off in any of the ways described above at any time after activation. When the control system 16 deactivates the system 10 (i.e., turns switch 70 off), both valves 56 and 64 are closed. The activation switch may be turned off and then turned on again at a later time provided there is sufficient fire retardant in the supply tank 50.

Control system 16 is capable of closing valves 56 and 64 at different times. For example, valve 56 may be closed before valve 64 so that the fire retardant tank is allowed to depressurize for an interval of time. Valve 64 is then closed by control system 16. If deactivation is accomplished through use of telephonic activation 76 before all fire retardant contained in tank 50 has been discharged through system 10, the fire retardant remaining in the pipes 20 downstream of tank 50 may be flushed out to clear the piping in the system to ready it for the next use. This is done by opening valves 56 and 67 with valve 64 closed. Valves 56 and 67 are allowed to remain open until all residual fire retardant has been discharged through the various nozzles.

The fire retardant used in the system 10 is preferably of the type that will remain on the surfaces onto which it has been sprayed, providing continuing protection against wildfire, until the retardant residual has been washed off.

It will be appreciated by those of ordinary skill in the art that certain modifications and additions may be made to the system 10 as described above and shown in the drawings. For example, the system may be designed to operate on a manual basis only, thereby omitting control system 16. In this case, only one manually operable valve may be used in place of valve 56 shown in the drawings and the system is activated by manually opening the valve to deliver gas from the pressure tank to the fire retardant tank. Also, a hose having a nozzle on one end may be connected to the fire retardant tank to allow retardant to be manually sprayed on specific locations. Separate lines may be plumbed into the system similar to standard hose bibs that allow firefighters to connect external hoses to the fire retardant supply. As yet another modification, large “gun” type of sprinkler heads such as impact heads may be mounted at tree-top level to provide greater coverage of the areas surrounding structures. Moreover, entire communities may be protected by a single, large scale installation along the lines noted above. In this case, each structure in a community would be individually protected by a system 10, and a community perimeter system for delivering fire retardant to a line around the community would be used.

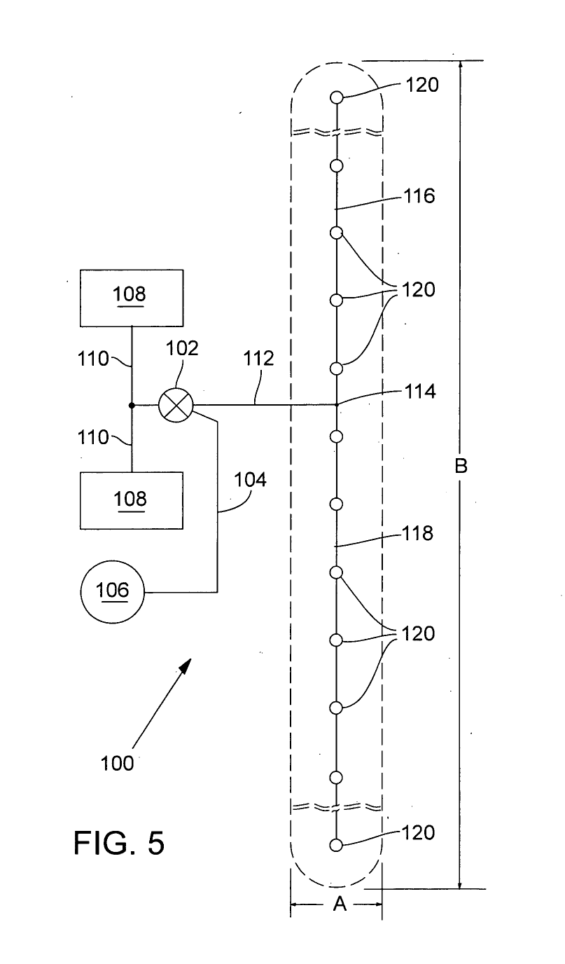

An alternative embodiment is shown in FIG. 5. In this system 100, which is the type of system that is used to flank a fire to control fire direction or stop the fire's progress in a specific direction, a series of “big gun” distribution heads are positioned to spray fire retardant in a line over a relatively long distance. In many areas, historical fire data are available that provides a reliable statistical indicator of the direction that wildfires travel. In other words, in any given area, by relying upon factors such as weather, wind patterns, fuel distribution, and historical fire data, firefighters are able to reliably predict wildfire direction and behavior. The system 100 is used to flank a fire by laying down a long line of fire retardant that is intended to stop a fire, or channel it away from a residential area, or toward an area where it is easier to fight, etc.

System 100 relies upon a compressed gas powered pump 102 that is powered by compressed gas delivered to pump 102 through a line 104 that interconnects the pump to a tank 106 of compressed gas. Pump 102 is preferably a diaphragm-type pump such as the IR ARO™ diaphragm pumps available from Ingersoll-Rand Fluid Products (www.arozone.com), and is preferably powered with compressed nitrogen or air in tank 106.

One or more reservoirs 108 of fire retardant are plumbed to pump 102 through pipes 110. The reservoirs 108 may be located underground, or remotely from pump 102, as may the tank 106, depending upon the specific location. A single outflow pipe 112 from pump 102 is connected to a T-fifting 114 and there are two branch lines 116, 118 extending from the T-fitting. Plural spray distribution heads 120 are plumbed inline in the branch lines 116 and 118—twelve distribution heads 120 are shown in the system 100 in FIG. 5.

Each distribution head 120 is preferably a “big gun” type of spray head configured to distribute a desired quantity of fire retardant. In the embodiment illustrated in FIG. 5, the system 100 is pressurized and the components are sized so that fire retardant is sprayed from each distribution head in a circle having a diameter of about 100 feet (dimension A in FIG. 5). It will be appreciated that the length of the perimeter line defined by branch lines 116 and 118 may be up to ¼ mile, and more, as shown by dimension B, FIG. 5. The area of ground onto which fire retardant is distributed with the system 100 is illustrated with dashed lines around the perimeter of the system.

Depending upon the area that is to be protected, several systems 100 may be arranged in series to provide a protection line that is many miles in length. The system 100 may beneficially be used to deliver fire retardant to at least a part of a perimeter around a residential area, and in particular those perimeter areas that are most prone to be hit by wildfire.

System 100 includes activation means for activating the system, which may be of any of the types described above.

While the present invention has been described in terms of a preferred embodiment, it will be appreciated by one of ordinary skill that the spirit and scope of the invention is not limited to those embodiments, but extend to the various modifications and equivalents as defined in the appended claims.

We Claim:

1. A fire retardant delivery system for protection from wildfire, comprising:
a compressed gas powered pump;
a supply of compressed gas connected to the pump;
a reservoir of fire retardant connected to the pump;
plural fire retardant distribution nozzles connected to the pump and arranged in a desired orientation to deliver fire retardant to a desired area.

2. The fire retardant delivery system according to claim 1 including activation means for activating the system and thereby deliver fire retardant through the distribution nozzles.

3. The fire retardant delivery system according to claim 1 wherein the supply of compressed gas comprises nitrogen.

4. The fire retardant delivery system according to claim 1 wherein the reservoir of fire retardant is non-pressurized.

5. The fire retardant delivery system according to claim 4 wherein the reservoir of fire retardant is located underground.

6. The fire retardant delivery system according to claim 2 wherein the means for activating the system includes telephony means for allowing remote connection to and operation of the activation means via telephone.

7. The fire retardant delivery system according to claim 1 wherein the fire distribution nozzles are arranged to deliver retardant to an area defining at least a partial perimeter around a structure to flank a fire and prevent the fire from reaching the structure.

8. A method of delivering fire retardant over a desired area to control a wildfire, comprising the steps of operating a compressed gas pump to deliver fire retardant from a reservoir of fire retardant to plural distribution nozzles, and to thereby deliver fire retardant over the desired area.

9. The method according to claim 8 wherein the desired area comprises at least a portion of a perimeter around a residential area.

10. The method according to claim 9 including activating the compressed gas pump remotely via telephone.

11. The method according to claim 8 including the step of locating the reservoir of fire retardant underground and locating the distribution nozzles in an area defining at least a partial perimeter around a structure.

12. A method of flanking a wildfire so that the wildfire does not reach a structure, comprising the steps of:
a) locating a compressed gas powered pump at a desired location relative to the structure;
b) fluidly connecting a supply of compressed gas to the pump;
c) fluidly connecting a reservoir of fire retardant to the pump;
d) positioning plural fire retardant distribution nozzles in a desired orientation relative to the structure and fluidly connecting the nozzles to the pump;
e) operating the pump to deliver fire retardant to the nozzles to thereby distribute fire retardant to a desired location relative to the structure.

13. The method according to claim 12 wherein fire retardant is delivered to an area defining at least a partial perimeter around a residential area.

14. The method according to claim 12 including the step of providing plural fire retardant delivery systems around plural structures, each fire retardant delivery system operable to deliver fire retardant according to the steps of:
a) locating a compressed gas powered pump at a desired location relative to the structure;
b) fluidly connecting a supply of compressed gas to the pump;
c) fluidly connecting a reservoir of fire retardant to the pump;
d) positioning plural fire retardant distribution nozzles in a desired orientation relative to the structure and fluidly connecting the nozzles to the pump;
e) operating the pump to deliver fire retardant to the nozzles to thereby distribute fire retardant to a desired location.

15. The method according to claim 13 wherein the plural fire retardant delivery systems operate together to deliver fire retardant to a perimeter area around said plural structures.

16. The method according to claim 13 wherein the location for delivery of fire retardant comprises a perimeter area that is between the structure and historical fire originating locations.

17. The method according to claim 13 wherein the location for delivery of fire retardant is selected based upon weather patterns.

18. The method according to claim 13 wherein the location for delivery of fire retardant is selected based upon wind patterns.

19. The method according to claim 13 wherein the location for delivery of fire retardant is selected based upon historical fire data.

20. The method according to claim 13 wherein the location for delivery of fire retardant is selected based upon fuel distribution patterns.
